(19) United States
(12) Patent Application Publication
(10) Pub. No.: US 2009/0250121 A1
(43) Pub. Date: Oct. 8, 2009

(54) Aquarium overflow system

(76) Inventor: Michael J. Kirkman, Nipomo, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/384,743

(22) Filed: Apr. 8, 2009

Related U.S. Application Data
(60) Provisional application No. 61/043,378, filed on Apr. 8, 2008.

(51) Int. Cl. A01K 63/04

(52) U.S. Cl. 137/386

(57) ABSTRACT

An aquarium overflow system for use with an aquarium tank to drain water from the tank to a sump system comprises an overflow box, a through-the-wall attachment mechanism for attaching the overflow box to the inside of a wall of the tank, an adapter for connecting the attachment mechanism to a conduit that hydraulically connects to the sump system and a baffle system inside the overflow box for reducing noise and ensuring consistent flow. In a preferred embodiment, the attachment mechanism comprises a bulkhead adapter having an insert portion extending through the wall of the tank, a bulkhead cap and gasket pressing against the outer surface of the wall and a bulkhead nut pressing the back wall of the overflow box, with a gasket therebetween, against the inside surface of the tank wall. An adjustable vent tube in the conduit adapter further reduces the noise associated with the overflow system.

### CROSS-REFERENCE TO RELATED APPLICATIONS

This patent application claims priority to U.S. Provisional Patent Application No. 61/043,378 filed Apr. 8, 2008.

### STATEMENT REGARDING FEDERALLY SPONSORED RESEARCH

Not Applicable.

### BACKGROUND OF THE INVENTION

A. Field of the Invention

The field of the present invention relates generally to apparatuses and systems for improving the operation of aquariums and the like. In particular, the present invention relates to such apparatuses and systems that are utilized with an aquarium tank to maintain the water level in the tank at a predetermined level and to facilitate circulation of water between the tank and an external sump and/or filter system. Even more particularly, the present invention relates to such apparatuses and systems that are configured to efficiently and quietly transfer water between the aquarium tank and external system.

B. Background

Many people have an aquarium for containing fish and plants in an aquatic environment and enjoy viewing the aquarium and having others view the aquarium. While a clean, well taken care of aquarium system can provide a healthy environment for the fish and plants and is enjoyable to view, an aquarium that is not well taken care of can be harmful for the fish and plants and, typically, is not pleasant to view. One of the main requirements for maintaining a healthy clean aquatic environment for an aquarium is the circulation of water into the aquarium tank and the maintaining of the water level in the tank. As well known to those involved with aquarium systems, it is important that the water quality parameters be controlled very precisely for the health of the aquatic life. A common method of maintaining the desired water quality parameters in the aquarium is to utilize conditioning devices and methods outside of the primary aquarium tank, that being the tank which holds the aquatic life. The external devices are commonly referred to as “sumps’, and this term will be use in the present disclosure to describe any external water quality maintenance system utilized with an aquarium tank.

In order to maintain water quality, the water to be conditioned must be removed from the aquarium tank, processed in the sump and then returned to the aquarium tank. The removal, processing and return of the water must be done in a manner that regulates the quantity of water removed and returned so as to control the water level in the aquarium tank. Typically, the removal of the water from the aquarium tank is accomplished by continuously moving water in a controlled manner from the aquarium tank into the sump. The water is processed in the sump, typically by utilizing one or more filters and/or other water processing equipment and methods, and then the processed water is returned to the aquarium tank by a return pump. The most common methods of removing water from the aquarium tank are an overflow system that utilizes a continuous siphon overflow box or a drain system that has one or more holes drilled in either the bottom or side walls of the aquarium tank, with some type of control device to maintain a consistent water level in the aquarium tank and flow rate into the aquarium tank. The continuous siphon type of overflow box requires a siphon being maintained, which is frequently a source of unwanted noise. The devices can lose their prime, particularly in the event of a power failure, which can result in the aquarium flooding the floor when pump operation resumes. In addition, these devices are usually large and cumbersome. The overflow devices that rely on holes drilled in the aquarium tank typically have large, unsightly housings for the drains. In addition, these devices often lack apparatuses to prevent siphoning, which results in the water level fluctuating and can be a source of undesirable noise.

The typical overflow system has a hanging overflow box that is mounted on the frame of the aquarium tank with the inlet into the overflow box positioned such that it is slightly below the desired water level of the aquarium tank. A siphon tube connects the overflow box to the sump, which includes a sump tank for holding the overflow water, where the water is processed. A pump operatively connected to the interior of the sump tank, typically in the sump tank, pumps the processed water back into the aquarium tank. The sump is commonly located below or behind the aquarium tank. As the processed water from the sump enters the aquarium tank, the water level in the aquarium tank rises and overflows into the overflow box, where the overflow water is transferred to the sump to complete its cycle.

Various prior art overflow devices have been patented. For instance, U.S. Pat. No. 6,770,194 to McGrath discloses a water overflow device that comprises an outer tube and an inner tube located axially within the outer tube to define an annular path therebetween. The outer tube and inner tube are held together by an overflow skimmer and a strainer and the entire device attaches to the bottom of the aquarium tank where water flows out the tank through the inner tube. U.S. Pat. No. 5,626,747 to Ritzow, et al. describes an overflow system having a pre-overflow wall that separates the aquarium tank into a main region and an intake region, with a filter intake located in the intake region. Openings in the pre-overflow wall are placed to attain a desired circulation pattern within the aquarium tank. U.S. Pat. No. 6,056,886 to Hickok, Jr., et al. describes a flow control device comprising an outflow conduit that allows water to flow downwardly out of the aquarium tank in a manner that prevents the generation of noise due to the outflow of the water. The inlet of the outflow conduit has a cap with a vent tube extending vertically downwardly through the cap and into the conduit to establish an air flow path. U.S. Pat. No. 3,785,493 to Harding describes an aquarium siphon that comprises a liquid receptacle which hangs on the outside of the aquarium tank to receive water from an inner/siphon tube that extends freely into a floating outer tube having a plurality of slots which extend through the surface of the water in the aquarium tank.

Despite the foregoing and other prior art, there exists a need for an improved aquarium overflow system that removes water from an aquarium tank to maintain the level of water in the tank while processed water is continuously added to the tank. The preferred aquarium overflow system should effectively and efficiently draw water from inside the aquarium tank while substantially eliminating any noise from the overflow system. Preferably, an improved aquarium overflow system should be adaptable to a wide variety of aquarium tanks, aquarium systems and sumps. The preferred overflow system should be relatively compact so it does not interfere with the operation of the aquarium system and does not utilize excessive space inside the aquarium tank. Preferably, an improved overflow system should be aesthetically pleasing, inexpensive to manufacture and reliable.

### SUMMARY OF THE INVENTION

The aquarium overflow system of the present invention provides the benefits and solves the problems identified above. That is to say, the present invention discloses an aquarium overflow system that is configured to remove water from inside an aquarium tank to maintain the desired water level in the tank while processed water is being continuously added to the tank in a manner that does not generate any significant noise. The aquarium overflow system of the present invention quietly, effectively and efficiently removes water from the top of the water in the aquarium tank to maintain a desired water level inside the tank. The present aquarium overflow system drains water from the aquarium tank utilizing a gravity fed drain placed through the side wall of the tank, providing an overflow system that is quiet in operation and less likely to fail. The aquarium overflow system of the present invention includes a component that continuously breaks any siphon to reduce noise and maintain a constant flow rate and a weir that maintains the water in the aquarium tank at a predetermined, constant level. The present aquarium overflow system allows more water to be moved while utilizing a much more compact device. The aquarium overflow system of the present invention is aesthetically pleasing, relatively inexpensive to manufacture and reliable.

In a primary embodiment of the present invention, the aquarium overflow system generally comprises an overflow box that is attached to the inside surface of one of the side walls of an aquarium tank, a hole in the overflow box that is aligned with a hole in the side wall of the aquarium tank, a mechanism for securely attaching the overflow box to the side wall of the aquarium tank by passing a conduit through the tank hole and the box hole, and tank conduit that interconnects the attaching mechanism to a sump system having a sump tank that receives water drained from the aquarium tank through the overflow box. In the preferred embodiment, the overflow box has a back wall, a front wall in spaced apart relation to the back wall, a first side wall, a second side wall in spaced apart relation to the first side wall and a bottom wall that, collectively, define a chamber that is substantially open at a top end of the overflow box and closed at a bottom end of the overflow box. At least the front wall of the overflow box defines a weir at the top end of the overflow box. In a preferred embodiment, the weir is defined by the top of the front wall and two side walls of the overflow box. The weir can comprise a plurality of slot members that form slots at the top of the overflow box. The overflow box is placed in the aquarium tank with the weir disposed below the water level of the aquarium tank so water flows into the chamber from the aquarium tank. The back wall of the overflow box, which has a box hole therethrough, is positioned substantially adjacent an inside surface of the side wall of the aquarium tank. The side wall of the aquarium tank has a tank hole therethrough which is in substantial alignment with the box hole. A portion of the attachment mechanism is received through the tank hole and the box hole to attach the overflow box to the inside surface of the side wall of the aquarium tank. The attachment mechanism is configured so as to hydraulically connect with the chamber and a tank conduit that connects with the sump system to drain water from the chamber to the sump tank. In a preferred embodiment, the attachment mechanism comprises a bulkhead tank adapter that has an insert portion which is received through the tank hole and the box hole to hydraulically connect the chamber and the tank conduit. A bulkhead nut can attach to a first end of the insert portion to secure the overflow box to the side wall of the aquarium tank. In the preferred embodiment, the first end of the insert portion and the bulkhead nut are both disposed in the chamber and the bulkhead tank adapter has a bulkhead cap, which is disposed at the outer surface of the aquarium side wall, at a second end of the insert portion. Preferably, a gasket or other sealing mechanism is positioned between the bulkhead cap and the outer surface of the side wall of the aquarium tank and another gasket or the like is positioned between the back wall of the overflow box and the inside surface of the aquarium tank. The preferred embodiment also has a conduit adapter interconnecting the bulkhead tank adapter and the tank conduit. The conduit adapter has a vent aperture in a top side of the conduit adapter and a vent tube that is slidably disposed in the vent aperture to reduce the noise associated with water draining from the aquarium tank. The preferred embodiment also has a baffle system that is disposed in the chamber of the overflow box to direct the flow of water from the aquarium tank into the bulkhead tank adapter through the chamber. The preferred baffle system comprises a pair of fixed baffle members attached to the back wall of the overflow box in the chamber and a removable baffle member that is disposed above the inlet into the bulkhead tank adapter in the chamber. The baffle system also reduces the noise of the aquarium overflow system and helps maintain a constant flow of water between the aquarium tank and the sump system.

Accordingly, the primary aspect of the present invention is to provide an aquarium overflow system that provides the benefits described above and solves the problems associated with presently available aquarium overflow apparatuses and systems.

It is an important aspect of the present invention to provide an aquarium overflow system that continuously removes water from inside an aquarium tank in order to maintain the desired water level in the tank while processed water from a sump is being added to the tank.

It is also an important aspect of the present invention to provide an aquarium overflow system that quietly, effectively and efficiently removes water from the aquarium tank so the water may be processed by a sump prior to being returned to the tank.

Another important aspect of the present invention is to provide an aquarium overflow system that utilizes a gravity fed drain placed through the side wall of the aquarium tank to continuously drain water from the tank in a manner which is quiet and reliable so as to maintain the water level in the tank while processed water is being added thereto.

Yet another important aspect of the present invention is to provide an aquarium overflow system that is relatively compact, inexpensive to manufacture and aesthetically pleasing.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of an aquarium system utilizing the aquarium overflow system of the present invention to drain water from the aquarium tank to the sump;

FIG. 2 is a side view of the aquarium overflow system of the present invention;

FIG. 3 is a cross-sectional view of the aquarium overflow system of FIG. 2 taken through line 3-3 of FIG. 2; and

FIG. 4 is an exploded side view of the aquarium overflow system of FIG. 2.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The accompanying figures are merely illustrative of one or more of the preferred embodiments and, as such, represent one or more ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain components and materials for those components, those who are skilled in the art will readily understand that this is merely for purposes of simplifying the present disclosure and that the present invention is not so limited.

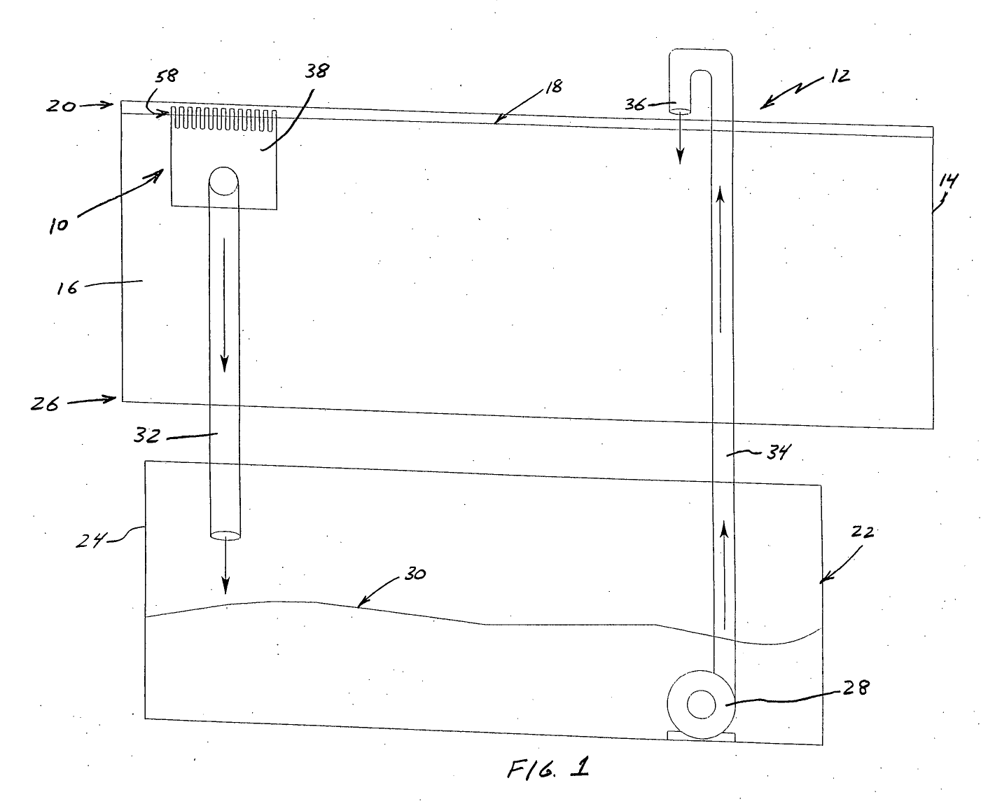

An aquarium overflow system that is configured pursuant to a preferred embodiment of the present invention is shown generally as 10 in the figures. As shown in FIG. 1, overflow system 10 is configured for use with an aquarium system 12 comprising an aquarium tank 14 having water 16 therein with a water level, shown as 18, generally at or near the top 20 of aquarium tank 14. The aquarium system 12 also comprises a sump system 22 configured to condition the water from aquarium tank 14. The typical sump system 22 has a sump tank 24 disposed below the bottom 26 of aquarium tank 14 and a return pump 28 disposed in the sump tank 24 below the sump water level 30. As set forth in more detail below, a quantity of water 16 is continuously drained from the aquarium tank 14 via the aquarium overflow system 10 and tank conduit 32 to sump system 22, processed in the sump tank 24 and then returned to aquarium tank 14 via the return pump 28, a sump conduit 34 interconnecting the return pump 28 and a discharge outlet 36 that discharges the processed water into the aquarium tank 14. The path of the water flow between the aquarium tank 14 and the sump system 22 is shown by the arrows on FIG. 1.

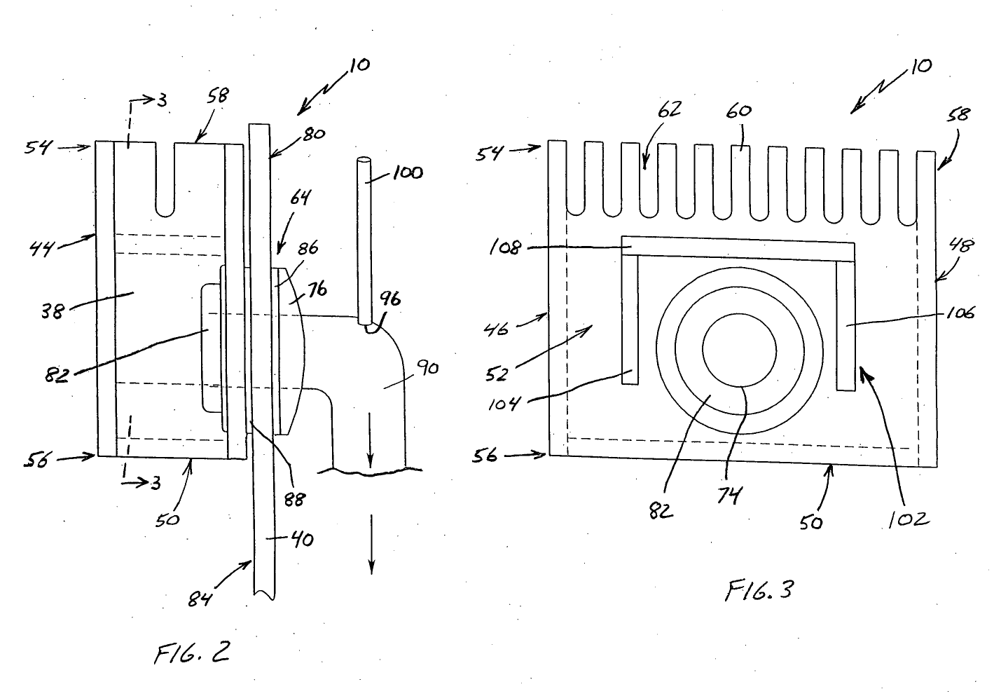

In the preferred embodiments shown in the figures, aquarium overflow system 10 comprises an overflow box 38 that is sized and configured to be received inside of aquarium tank 14 and attached to one of the side walls, shown as 40 in FIGS. 2 and 4, of aquarium tank 14. Overflow box 38 has a back wall 42, a front wall 44 disposed in spaced apart relation to the back wall 42, a first side wall 46, a second side wall 48 in spaced apart relation to the first side wall 46 and a bottom wall 50 that defines a chamber 52 that is open at the top end 54 of overflow box 38 and closed at the bottom end 56 of overflow box 38, as best shown in FIGS. 2 through 4. The front wall 44, first side wall 46 and second side wall 48 form a weir 58 at the top end 54 of overflow box 38 over which water 16 in aquarium tank 14 at or near the water level 18 will flow into the chamber 52 and, ultimately, into tank conduit 32 to flow to sump tank 24. As set forth in more detail below, overflow box 38 is attached to the side wall 40 of aquarium tank 14 near the top 20 of aquarium tank 14 such that the weir 58 will define the water level 18 in aquarium tank 14. Water 16 in aquarium tank 14 above weir 58 will flow across the top end 54 of overflow box 38 into chamber 52 to flow through tank conduit 32 and discharge to sump tank 24. In the embodiment shown in the figures, overflow box 38 has a slotted weir 58 formed by a plurality of spaced apart slot members 60 defining slots 62 therebetween. An advantage of the slotted weir 58 shown in the figures is that it may help prevent any of the inhabitants of aquarium tank 14 from flowing into chamber 52 of overflow box 38. An advantage of a non-slotted, straight edge weir 58 is that such a configuration may better skim the surface of water 16.

As best shown in FIGS. 2 and 4, the overflow box 38 is attached to the side wall 40 of aquarium tank 14 with an attachment means 64 that engages a tank hole 66 in the side wall 40 of aquarium tank 14 and a box hole 68 in the back wall 42 of overflow box 38. As will be readily understood by those skilled in the art, the tank hole 66 and box hole 68 are cooperatively configured such that the size, shape and position of tank hole 66 corresponds to the size, shape and position of box hole 68 to place the overflow box 38 against side wall 40 at the desired height of water level 18, which will be controlled by weir 58, in aquarium tank 14. Typically, most aquarium tanks 14 do not have a tank hole 66 in one of their side walls 40. As such, tank hole 66 will usually have to be drilled by the user of aquarium overflow system 10 in order to install overflow box 38 on the side wall 40. A diamond coated hole saw can be utilized to cut tank hole 66 in the side wall 40 of aquarium tank 14. Overflow box 38 can be provided with box hole 68 already in back wall 42, for instance included during the manufacturing process by molding or cutting, or the user can cut box hole 68 with a hole saw suitable for the material of back wall 42 (typically plastic or the like). Attachment means 64 is sized and configured to be received through tank hole 66 and box hole 68 to engage the back wall 42 of overflow box 38 to hold overflow box 38 in position against side wall 40 of aquarium tank 14. Typically, but not exclusively, the side wall 40 will be at the back of aquarium tank 14 to reduce the visual impact of the aquarium overflow system 10 on the aquarium system 12.

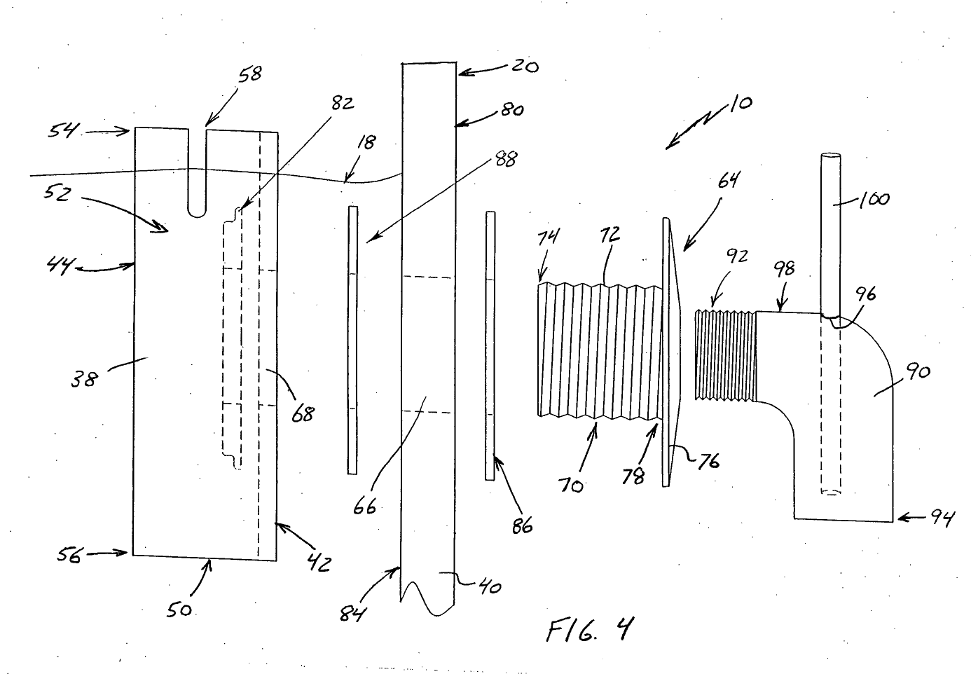

In a preferred embodiment, attachment means 64 comprises a bulkhead tank adapter 70 having a tubular insert portion 72 sized and configured such that the first end 74 thereof will extend through the tank hole 66 and box hole 68 into chamber 52, as shown in FIG. 3. Bulkhead tank adapter 70 also has a bulkhead cap 76 at the second end 78 of the tubular insert portion 72 that has an outward extending ring-like configuration to engage the outer surface 80 of the side wall 40 of aquarium tank 14, as best shown in FIGS. 2 and 4. In a preferred embodiment, the bulkhead tank adapter 70 is a single integral component that is threaded along at least the inward section, the area received inside of chamber 52, of insert portion 72. The attachment means 64 of the preferred embodiment also comprises a bulkhead nut 82 that is configured to engage the insert portion 72 of the bulkhead tank adapter 70 to press the back wall 42 of overflow box 38 against the inside surface 84 of the side wall 40 of aquarium tank 14, as shown in FIG. 2. In the preferred embodiment, bulkhead nut 82 is configured to threadably engage the insert portion 72 of the bulkhead tank adapter 70. Various other connection mechanisms can also be utilized to connect the bulkhead nut 82 to the bulkhead tank adapter 70.

The preferred embodiment of the aquarium overflow system 10 of the present invention also comprises a first sealing means 86, such as a ring-shaped gasket, disposed between the bulkhead cap 76 and the outer surface 80 of the side wall 40 of aquarium tank 14 to prevent water 16 from leaking outside of aquarium tank 14. The aquarium overflow system 10 also comprises a second sealing means 88, which may also be a ring-shaped gasket, disposed between the back wall 42 of overflow box 30 and the inside surface 84 of the side wall 40 of aquarium tank 14, as best shown in FIG. 4. The second sealing 88 means is provided to prevent the leakage of water into the overflow box 38 in the event of a power failure.

The aquarium overflow system 10 of the present invention also has a conduit adapter 90 configured to interconnect the bulkhead tank adapter 70 with the tank conduit 32. In the preferred embodiment, as shown in FIGS. 2 and 4, conduit adapter 90 is a ninety degree elbow having a threaded end 92 configured to threadably engage the bulkhead cap 76 of bulkhead tank adapter 70. The opposite end 94 joins conduit adapter 90 to the tank conduit 32 to hydraulically interconnect the chamber 52 inside overflow box 38 and the sump tank 24 so water 16 can flow from the aquarium tank 14 to the sump tank 24, as shown in FIG. 1. In the preferred embodiment of the present invention, the conduit adapter 90 has a vent aperture 96 at the top side 98 thereof, as best shown in FIG. 4, to receive a vent tube 100 therein. Preferably, vent aperture 96 is sized and configured to slideably receive, typically with a tight fit, vent tube 100. The venting of conduit adapter (e.g., elbow) 90 with vent tube 100 will prevent the formation of a siphon, which will maintain a more constant flow rate and lower sound. Because the vent tube 100 is adjustably received (slidably) inside vent aperture 96, the user can vary the location of the lower end of vent tube 100 inside conduit adapter 90 or tank conduit 32 to obtain the minimum sound output for his or her aquarium overflow system 10.

The aquarium overflow system 10 also comprises a baffle system 102 that is configured to cause the water 16 to be drawn, by gravity flow, into the first end 74 of the insert portion 72 of the bulkhead tank adapter 70, and therefore to the tank conduit 32 and sump system 22, below the water level 18 in aquarium tank 14. Because the water 16 is drawn into the drain below the surface of the water inside overflow box 38, the noise from aquarium overflow system 10 will be significantly reduced. As such, baffle system 102 controls the flow of water 16 once it flows inside of chamber 52. In one configuration, the baffle system 102 is in a squared off upside down U-shape that directs the water 16 flowing over the weir 58 into the bulkhead tank adapter 70. The baffle system 102 can comprises a pair of generally vertically disposed, spaced apart first baffle member 104 and second baffle member 106 that are fixedly attached to the back wall 42 of overflow box 38 and a generally horizontally disposed third baffle member 108 that rests on the upper end of the first 104 and second 106 baffle members to direct water 16 around the sides of the baffle system 102 to the first end 74 of inlet portion 72 of the bulkhead tank adapter 70. As set forth below, the use of a removable third baffle member 108 facilitates the installation and removal of aquarium overflow system 10 from aquarium tank 14. As stated above, the purpose of baffle system 102 is to ensure that the first end 74 of inlet portion 72 of the bulkhead tank adapter 70, therefore the inlet to the drain which drains water 16 to the sump tank 24, remains below the surface of the water inside chamber 52 of the overflow box 38 to substantially reduce the noise associated with continuously draining water 16 out of aquarium tank 14.

The aquarium overflow system 10 of the present invention can be made out of a variety of different materials and in a variety of different sizes. For instance, the overflow box 38 and baffle system 102 can be made out of a cast cell acrylic and the bulkhead tank adapter 70 and conduit adapter 90 can be commercially obtainable components made out of PVC or other materials. Various other plastics or and non-plastic materials can be used for any or all of the components of aquarium overflow system 10. In addition, a number of the components of aquarium overflow system 10 can be made integral or fixedly attached to each other. For instance, the overflow box 38 could be molded to also form weir 58, first 104 and second 106 baffle members and portions of the bulkhead tank adapter 70 as a single unit. For instance, the bulkhead tank adapter 70 could be reversed with the insert portion 72 passing from the inside of overflow box 38 to the outer surface 80 of the side wall 40 of aquarium tank 14 so a bulkhead nut 82 could be attached on the outside of aquarium tank 14 instead of inside chamber 52. Various other alternative configurations could be utilized for aquarium overflow system 10. The size of the components of aquarium overflow system 10 can be adjusted to accommodate different desired flow rates out of aquarium tank 14. For example, an aquarium overflow system 10 having an overflow box 3.25″ high by 5″ wide and 2″ deep with a 1″ diameter bulkhead tank adapter 70 and conduit adapter 90 and a 0.25″ vent tube 100 can achieve a flow rate of 300 gallons per hour. An aquarium overflow system 10 having an overflow box 6″ high by 6.25″ wide and 2″ deep with a 1.5″ diameter bulkhead tank adapter 70 and conduit adapter 90 and a 0.375″ vent tube 100 can achieve a flow rate of 700 gallons per hour. An aquarium overflow system 10 having an overflow box 6″ high by 12.25″ wide and 2″ deep with dual 1.5″ diameter bulkhead tank adapter 70 and conduit adapter 90 and a 0.375″ vent tube 100 can achieve a flow rate of 1500 gallons per hour. An aquarium overflow system 10 having an overflow box 7″ high by 18.25″ wide and 3.75″ deep with dual 2″ diameter bulkhead tank adapter 70 and conduit adapter 90 and a 0.5″ vent tube 100 can achieve a flow rate of 3600 gallons per hour. The above sizes are set forth above for exemplary purposes only and are not intended to limit the present invention in any manner. As stated above, a wide variety of sizes, including custom sizes, can be incorporated into aquarium overflow system 10 to achieve different water flow rates.

To install the aquarium overflow system 10 the user places the overflow box 38 against the inside surface 84 of the side wall 40 of aquarium tank 14 generally near the top 20 of aquarium tank 14 at a location where the user wants the water level 18 to be, as defined by the weir 58. The user marks this location and, preferably, utilizes a template to identify the location of the tank hole 66. Using a hole saw configured to cut glass or any other material which the side wall 40 of aquarium tank 14 is made, the user cuts tank hole 66. The user then inserts the insert portion 72 of the bulkhead tank adapter 70 through the tank hole 66 and into the interior of the aquarium tank 14, typically with the conduit adapter 90 attached and first sealing means 86 disposed around the insert portion 72 between the bulkhead cap 76 and the outer surface 80 of the side wall 40 of the aquarium tank 14. The second sealing means 88 is then placed around the insert portion 72 and the box hole 68 on the back wall 42 of overflow box 38 is aligned with the insert portion 72 and placed thereon, disposing the second sealing means 68 between the back wall 42 and the inside surface 84 of the side wall 40 of aquarium tank 14. With the third baffle member 108 removed, the user then attaches the bulkhead nut 82 to securely attach the overflow box 38 to the aquarium tank 14. The third baffle member 108 is then placed on top of the first 104 and second 106 baffle members. If not already attached, the user then attaches the tank conduit 32 to the conduit adapter 90 to hydraulically connect the inside of aquarium tank 14 to the sump tank 24 of sump system 22. With the water 16 in aquarium tank 14 and the sump system 22 pumping processed water into aquarium tank 14, the aquarium overflow system 10 of the present invention will automatically and continuously drain water 16 from aquarium tank 14, by the water 16 flowing over weir 58 onto baffle system 102 and into the hydraulically connected bulkhead tank adapter 70, conduit adapter 90 and tank conduit 32, to the sump tank 24 for conditioning and then redirecting into aquarium tank 14. Because the inlet, which is at or near the first end 74 of insert portion 72 of the bulkhead tank adapter 70, into the drain system will be below the surface of the water inside the overflow box 38, the transfer of water 16 to the sump system 22 will be very quiet.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. An aquarium overflow system for use with an aquarium tank having a side wall, said system comprising:
an overflow box having a back wall, a front wall in spaced apart relation to said back wall, a first side wall, a second side wall in spaced apart relation to said first side wall and a bottom wall defining a chamber substantially open at a top end of said overflow box and closed at a bottom end of said overflow box, at least said front wall defining a weir at said top end of said overflow box, said overflow box received in said aquarium tank with said weir disposed below the water level of said aquarium tank so as to receive water into said chamber from said aquarium tank, said back wall of said overflow box positioned substantially adjacent an inside surface of said side wall of said aquarium tank, said back wall of said overflow box having a box hole therethrough;
a tank hole through said side wall of said aquarium tank, said tank hole in substantial alignment with said box hole;
an attachment means interconnecting said overflow box and said aquarium tank for securely attaching said overflow box to said side wall of said aquarium tank, a portion of said attachment means received through said tank hole and said box hole to attach said overflow box to said inside surface of said side wall of said aquarium tank, said attachment means configured so as to hydraulically connect with said chamber; and
a tank conduit interconnecting said attachment means with a sump system to drain water from said aquarium tank to a sump tank in said sump system.

2. The aquarium overflow system of claim 1, wherein said weir comprises a plurality of slot members defining a plurality of slots.

3. The aquarium overflow system of claim 1, wherein said attachment means comprises a bulkhead tank adapter having an insert portion received in said tank hole and said box hole, said bulkhead tank adapter hydraulically interconnecting said chamber and said tank conduit.

4. The aquarium overflow system of claim 3 further comprising a bulkhead nut engagedly connected to a first end of said insert portion so as to secure said overflow box to said side wall of said aquarium tank.

5. The aquarium overflow system of claim 4, wherein said first end of said insert portion and said bulkhead nut are disposed in said chamber, said bulkhead tank adapter further comprising a bulkhead cap at a second end of said insert portion, said bulkhead cap disposed at an outside surface of said side wall of said aquarium tank.

6. The aquarium overflow system of claim 5 further comprising a first sealing means disposed between said bulkhead cap and said outer surface of said side wall of said aquarium tank for sealing said tank hole at said outer surface.

7. The aquarium overflow system of claim 5 further comprising a second sealing means disposed between said back wall of said overflow box and said inside surface of said aquarium tank.

8. The aquarium overflow system of claim 1 further comprising a conduit adapter interconnecting said attachment means and said tank conduit.

9. The aquarium overflow system of claim 8 further comprising a vent aperture in a top side of said conduit adapter and a vent tube disposed in said vent aperture.

10. The aquarium overflow system of claim 9, wherein said vent tube is slidably disposed in said vent aperture.

11. The aquarium overflow system of claim 1 further comprising a baffle system disposed in said chamber of said overflow box, said baffle system configured to direct the flow of water from said aquarium tank into said attachment means through said chamber.

12. The aquarium overflow system of claim 11, wherein said baffle system comprises a pair of fixed baffle members fixedly attached to said back wall of said overflow box in said chamber and a removable baffle member disposed above said attachment means in said chamber.

13. An aquarium overflow system for use with an aquarium tank having a side wall, said system comprising:
an overflow box having a back wall, a front wall in spaced apart relation to said back wall, a first side wall, a second side wall in spaced apart relation to said first side wall and a bottom wall defining a chamber substantially open at a top end of said overflow box and closed at a bottom end of said overflow box, at least said front wall defining a weir at said top end of said overflow box, said overflow box received in said aquarium tank with said weir disposed below the water level of said aquarium tank so as to receive water into said chamber from said aquarium tank, said back wall of said overflow box positioned substantially adjacent an inside surface of said side wall of said aquarium tank, said back wall of said overflow box having a box hole therethrough;
a tank hole through said side wall of said aquarium tank, said tank hole in substantial alignment with said box hole;
an attachment means interconnecting said overflow box and said aquarium tank for securely attaching said overflow box to said side wall of said aquarium tank, said attachment means comprising a bulkhead tank adapter having an insert portion received through said tank hole and said box hole to attach said overflow box to said inside surface of said side wall of said aquarium tank, said bulkhead tank adapter hydraulically connected to said chamber;
a tank conduit interconnecting said bulkhead tank adapter with a sump system to drain water from said aquarium tank to a sump tank in said sump system; and
a baffle system disposed in said chamber of said overflow box, said baffle system configured to direct the flow of water from said aquarium tank into said bulkhead tank adapter through said chamber.

14. The aquarium overflow system of claim 13 further comprising a bulkhead nut engagedly connected to a first end of said insert portion of said bulkhead tank adapter so as to secure said overflow box to said side wall of said aquarium tank.

15. The aquarium overflow system of claim 14, wherein said first end of said insert portion and said bulkhead nut are disposed in said chamber, said bulkhead tank adapter further comprising a bulkhead cap at a second end of said insert portion, said bulkhead cap disposed at an outside surface of said side wall of said aquarium tank.

16. The aquarium overflow system of claim 15 further comprising a first sealing means disposed between said bulkhead cap and said outer surface of said side wall of said aquarium tank for sealing said tank hole at said outer surface.

17. The aquarium overflow system of claim 16 further comprising a second sealing means disposed between said back wall of said overflow box and said inside surface of said aquarium tank.

18. The aquarium overflow system of claim 13 further comprising a conduit adapter interconnecting said bulkhead tank adapter and said tank conduit, a vent aperture in a top side of said conduit adapter and a vent tube slidably disposed in said vent aperture.

19. An aquarium overflow system for use with an aquarium tank having a side wall, said system comprising:
an overflow box having a back wall, a front wall in spaced apart relation to said back wall, a first side wall, a second side wall in spaced apart relation to said first side wall and a bottom wall defining a chamber substantially open at a top end of said overflow box and closed at a bottom end of said overflow box, at least said front wall defining a weir at said top end of said overflow box, said overflow box received in said aquarium tank with said weir disposed below the water level of said aquarium tank so as to receive water into said chamber from said aquarium tank, said back wall of said overflow box positioned substantially adjacent an inside surface of said side wall of said aquarium tank, said back wall of said overflow box having a box hole therethrough;
a tank hole through said side wall of said aquarium tank, said tank hole in substantial alignment with said box hole;
an attachment means interconnecting said overflow box and said aquarium tank for securely attaching said overflow box to said side wall of said aquarium tank, said attachment means comprising a bulkhead tank adapter having an insert portion received through said tank hole and said box hole to attach said overflow box to said inside surface of said side wall of said aquarium tank, said bulkhead tank adapter hydraulically connected to said chamber;
a first sealing means disposed between said bulkhead tank adapter and an outer surface of said side wall of said aquarium tank;
a second sealing means disposed between said back wall of said overflow box and said inside wall of said aquarium tank;
a conduit adapter connected to said bulkhead tank adapter, said conduit adapter having a vent aperture at a top side thereof and a vent tube slidably disposed in said vent aperture;
a tank conduit interconnecting said conduit adapter and a sump system to drain water from said aquarium tank to a sump tank in said sump system; and
a baffle system disposed in said chamber of said overflow box, said baffle system configured to direct the flow of water from said aquarium tank into said bulkhead tank adapter through said chamber.

20. The aquarium overflow system of claim 19 further comprising a bulkhead nut engagedly connected to a first end of said insert portion of said bulkhead tank adapter so as to secure said overflow box to said side wall of said aquarium tank, said first end of said insert portion and said bulkhead nut disposed in said chamber, said bulkhead tank adapter further comprising a bulkhead cap at a second end of said insert portion, said bulkhead cap disposed at an outside surface of said side wall of said aquarium tank.
